(19) United States
(12) Patent Application Publication
(10) Pub. No.: US 2024/0171405 A1
(43) Pub. Date: May 23, 2024

(54) DECENTRALIZED PERSONAL DATA DISTRIBUTION AND TRACKING USING BLOCKCHAINS

(71) Applicant: Bitvore Corp., Los Angeles, CA (US)

(72) Inventor: Greg Bolcer, Yorba Linda, CA (US)

(21) Appl. No.: 17/990,534

(22) Filed: Nov. 18, 2022

(51) Int. Cl. H04L 9/32; G06Q 50/26

(52) U.S. Cl. CPC H04L 9/3247; G06Q 50/265; H04L 9/3213

(57) ABSTRACT

A system with a content provider and service provider is used to maintain and communicate one or more data containers comprising private information and privacy settings of a user. The service provider may provide a social network service that accesses various personal information. A smart contract is determined according to the privacy settings of the user, such that a user my opt-in and opt-out of allowing access to a wide range of applications.

### BACKGROUND

Limitations and disadvantages of conventional methods and systems for distribution of personal data will become apparent to one of skill in the art, through comparison of such approaches with some aspects of the present method and system set forth in the remainder of this disclosure with reference to the drawings.

### BRIEF SUMMARY

Methods and systems are provided for distribution of personal data and tracking via blockchains, substantially as illustrated by and/or described in connection with at least one of the figures, as set forth more completely in the claims.

### BRIEF DESCRIPTION OF THE DRAWINGS

FIG. 1 illustrates an example system for data containers and controlling NFT tokens, in accordance with various example implementations of this disclosure.

FIG. 2 illustrates an example of a present system for access and tracking, in accordance with various example implementations of this disclosure.

FIG. 3 illustrates an example system for user private access and tracking, in accordance with various example implementations of this disclosure.

FIG. 4 illustrates an example of data container metadata, in accordance with various example implementations of this disclosure.

FIG. 5 illustrates a data container usage example, in accordance with various example implementations of this disclosure.

FIG. 6 illustrates an example of an Apache ORC file as a data container, in accordance with various example implementations of this disclosure.

FIG. 7 illustrates an authorization, in accordance with various example implementations of this disclosure.

FIG. 8 illustrates an example wallet, in accordance with various example implementations of this disclosure.

FIG. 9 illustrates an example of searching and building libraries, in accordance with various example implementations of this disclosure.

FIG. 10 illustrates an example of usage and tracking of NFT libraries, in accordance with various example implementations of this disclosure.

FIG. 11 illustrates an example method for user private access and tracking, in accordance with various example implementations of this disclosure.

### DETAILED DESCRIPTION

A company (social media or otherwise) may monetize a user's private information (e.g., clicks, searches, mobile geographical data, purchases, etc.), without the user being aware. Terms of service may generically disclose what and how the data is used. However, terms of service are not user friendly, are difficult to read and provide no compliance guarantees and no verification that the data is being used properly. Furthermore, data breaches are outside a company's control. Therefore, there exists a need for a user to control their own personal data.

As disclosed herein, a user is able to control access to their data via one or more data containers. The data container may comprise virtual data containers that are assigned to a unique ID and associated with a token (e.g., NFT). The data container may comprise closed data (i.e. a static set of content) and/or open data (i.e., an ongoing stream of data or a dataset the composition of which changes over time). The token and the data container may be codified and packaged at the time of request, in an ongoing manner, on a schedule and/or on demand. The data that a user controls may comprise their own data, data they are chaperoning, and/or data of which they have a fractional ownership, and/or other form of data. Each data container may be assigned a unique ID that is globally unique, non-fungible and/or trackable. Enforcement of the proper usage of data within the data container may be maintained via tool integration and token verification. A user may be asked to approve the construct and/or composition of a data container via a pre-approved smart contract with token access and tracking. Alternatively, a user may be asked to approve or “opt in” per task as it happens. Users may share in value generated from their private or public data via multiple mechanisms, such as payments in fiat currency (e.g. US dollars), payments in crypto, discounts, incentives and/or access.

A data container may comprise columnar or tabular data, or may be comprised in whole or in part of unstructured data (e.g., a json file may comprise semi-structured data). The content of the data may comprise, for example, media or multimedia (e.g., images, video, music), free form text or unstructured data, auxiliary information (e.g., about purposes, usage, metadata, indexes, search terms), links or unique IDs to other data containers that make up a set or collection, links or unique IDs to preceding and anteceding data containers in a series/sequence (including the first and last in the series/sequence), 3D models, software, web apps, and/or decentralized apps. Individual items or fields may be encrypted.

There are multiple ways to implement alternate data containers as long as they have the data and can be associated with the unique ID, and can verify a token when the container is accessed, e.g. SOLite, Docker containers, others.

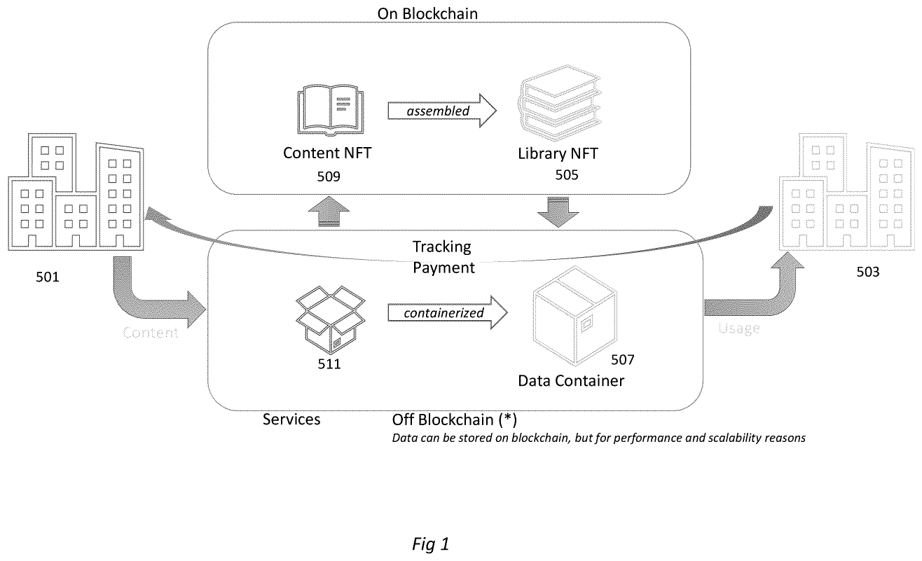

FIG. 1 illustrates an example system for data containers and controlling NFT tokens, in accordance with various example implementations of this disclosure.

Data is split into producers 501 and consumers 503 for competitive and/or privacy reasons. Producers 501 are not be allowed to see what other producers are providing. Consumers 503 are not be allowed to see what other consumers are using. A particular entity can be both a producer 501 and a consumer 503. For example, the particular entity may use/consume information to produce derivative information or reformulations for a third-party consumer. Tracking and provenance from the original producer to the third-party consumer is maintained using a blockchain.

When pieces of data 511 are containerized into a data container 507, a library NFT 505 is generated from content NFTs 509 that are associated with the pieces of data 511. Library NFT 505 generation may also occur when a consumer calls the data container 507 to use the data 511 inside.

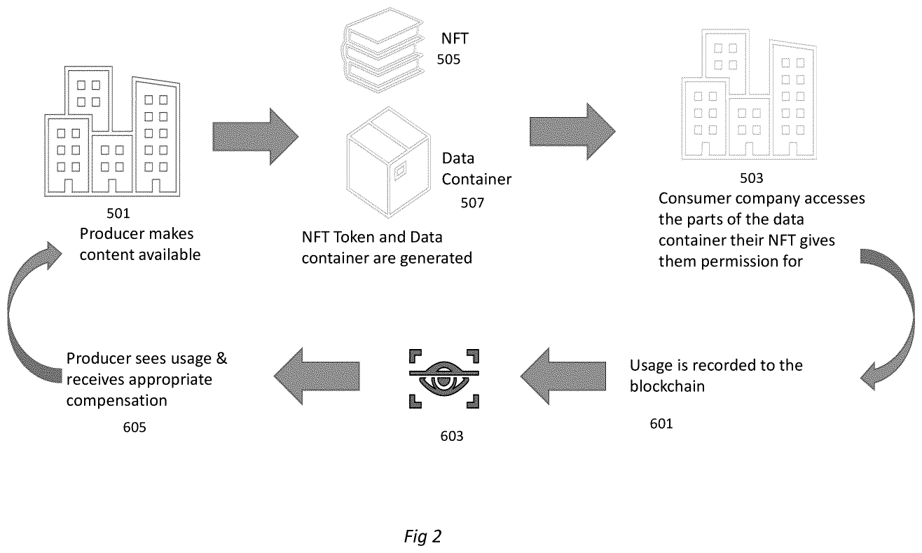

FIG. 2 illustrates an example of a present system for access and tracking, in accordance with various example implementations of this disclosure.

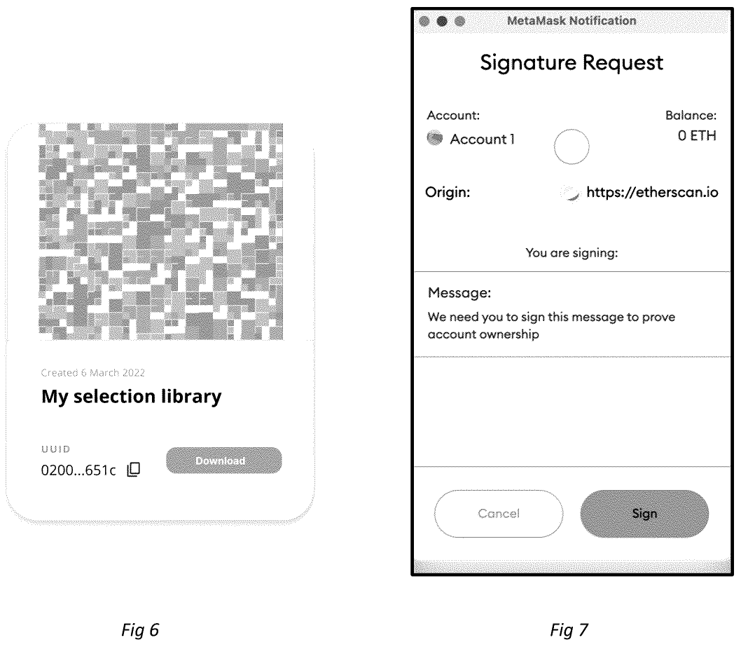

In FIG. 2, a user (e.g., human) is added to the loop. The data container 507 of FIG. 6 may comprise data (e.g., private information) that is under the user's control. After the consumer company 503 accesses the parts of the data container 507 their NFT 505 gives them permission for, usage is recoded in a blockchain at 601. The user may also be notified that their data is intended to be used or included and asked to approve the transaction at 603. This can be accomplished by sending a user a link, whereby a user logs into an app (e.g., a Web3 app) using their wallet. The wallet controls the NFT token 505 and allows the user to approve the contents of the data container 507. The producer 501 sees usage and receives appropriate compensation at 605.

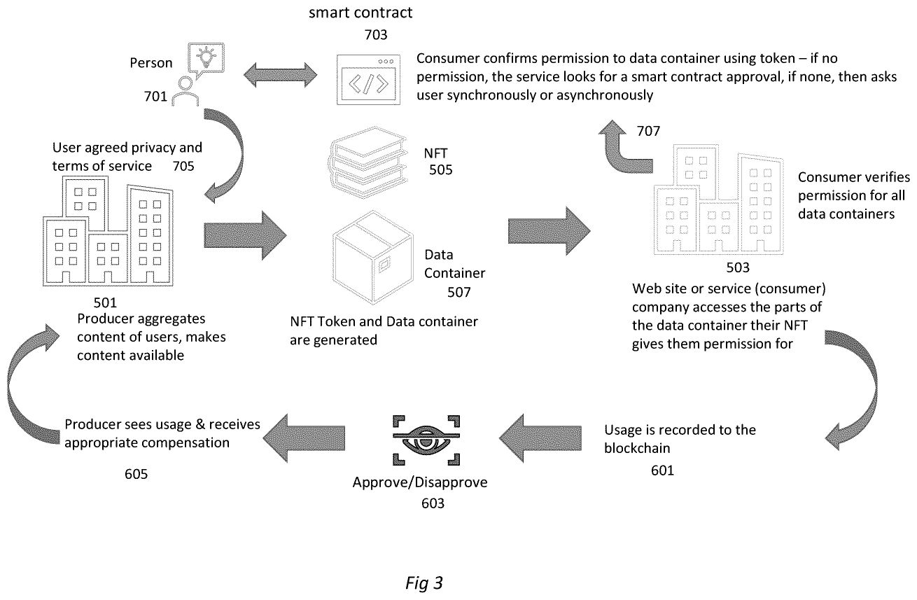

FIG. 3 illustrates an example system for user private access and tracking, in accordance with various example implementations of this disclosure.

A user 701 may have their data containers 507 generated and stored for them, on demand, ongoing, or at one time. The user 701 can store their own data containers 507 or have them stored centrally with producer 501 that acts as a privacy provider for users' data or a privacy aggregator for such data. The user 701 may have a plurality of different data containers 507 per service or family of services. For example, Instagram and Facebook may have aggregated data containers per user across their different applications, e.g. mobile, metaverse, Web, or 3rd party Web access. Access may be allowed via any of a user's sign-ins.

An aggregator/producer 501 may obtain all data 507 from all services the user 701 uses and store it for them in a token 505 protected data container 507 on an ongoing basis and provide compensation to the user 701. The aggregator/producer 501 may provide compliance services, tracking services, storage and promotion according to terms of service to which a user actually understands and agrees at 705.

The aggregator/producer 501 provides the user 701 with a smart contract 703 that allows them to opt-in or opt-out of having data (or certain portions of data) included in a library NFT 505. A service provider (e.g., social media or e-commerce site) is a potential consumer 503 of the user's data container 507.

When the user 701 signs up to a service, they would be asked to agree to new terms of service at 707 from the potential consumer 503. This invokes the smart contract 703 that can be updated based on the user's privacy settings. When that social media service (i.e., private information consumer) 503 includes, uses, sells or licenses the users' data (in bulk, individually and/or anonymized) 507, the smart contract 703 is also tracked and enforced using NFT tokens 505 and blockchain. Third-party 503 usage is then tracked 601 and access rules and controls are enforced using the same delivery and tracking mechanism. Users do not need to be involved and their smart contract 703 may change according to their privacy settings within the media site.

A user can be notified in real-time at 603 if and when their data container (or any data container using any of their data) is being packaged or used. Alternatively, the users may opt in and approve or disapprove the permissions automatically based on the notification using their wallet or other notification method, which controls the NFT token for a particular data container. The users' approval may also be tracked.

The processes described above in reference to FIGS. 1-3 can be recursively called as many times as needed as a content/data producers 501 can also be content/data consumers 503 or vice versa.

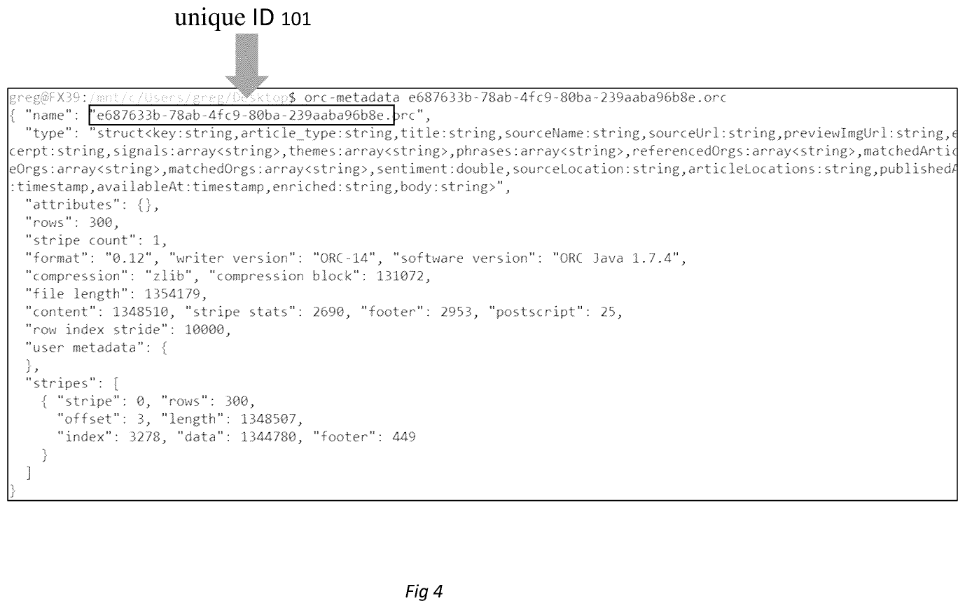

FIG. 4 illustrates an example of data container metadata, in accordance with various example implementations of this disclosure. As illustrated, an example of a unique ID 101 for access to a data container tied to an NFT token: e687633b-78ab-4fc9-80ba-239aaba96b8e.

There are diff types of data including json, csv, raw text, etc. Some containers might also include programming or executable content that can self-verify the content, verify the access, transform the content in some way, or display it in some way. In fact, a complete virtual machine or virtual data+code+storage like a Kubernetes or VMware instance could be considered a container also.

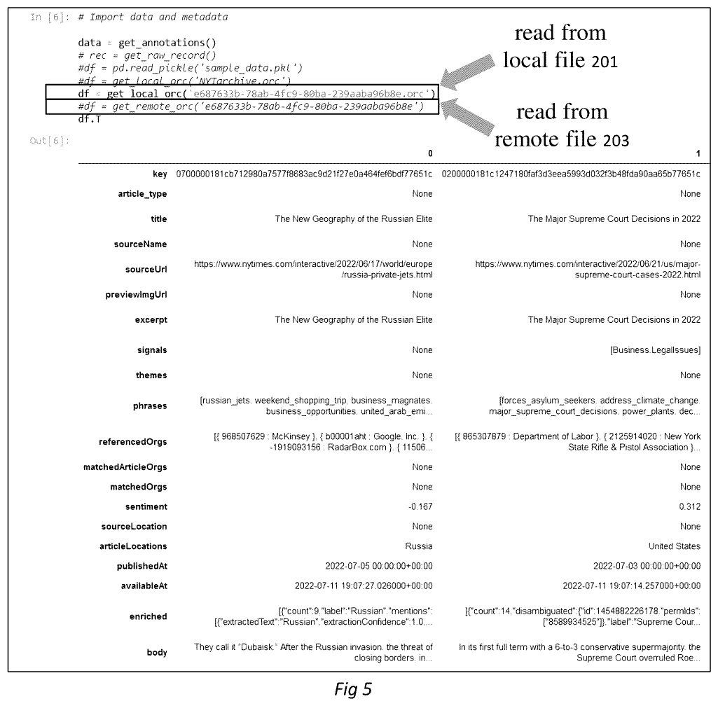

FIG. 5 illustrates a data container usage example, in accordance with various example implementations of this disclosure. FIG. 2 shows an example command to read from a local file 201:
DATA FRAME=get_local_orc(‘e687633b-78ab-4fc9-80ba-239aaba96b8e.orc’), and an example command to read from a remote file 203:
df=get_remote_orc(‘e687633b-78ab-4fc9-80ba-239aaba96b8e’). A data container may also be accessed via a URL:
url=“http://10.230.10.7:9091/orc/get/{uuid}”.

FIG. 6 illustrates an example of an Apache ORC file as a data container, in accordance with various example implementations of this disclosure.

NFTs may be used to control access to data, as a method of ensuring data security. For example, NFTs may be used as a way of locking and unlocking access to a company's proprietary and confidential data pertaining to an individual or as a way of locking and unlocking access to other data that a person or entity may control. FIG. 7 illustrates an authorization, in accordance with various example implementations of this disclosure.

A set of data may be spread across multiple containers. A data container may contain a universally unique identifier (UUID) and a link to a first data container in a sequence, a next data container(s) in a sequence, a previous data container in a sequence and/or a last data container in a sequence. The data containers may be cached locally. The data containers may comprise limited permissions that are accessible upon unlocking. Unlocking may be possible via a crypto wallet and signature request as shown in FIG. 7. Approval requests may be time-restricted and/or may be limited to a certain number of times accessed.

Most blockchains are public, and anyone using a public blockchain may review and audit all of the associated transactions. In contrast, private blockchains only grant access to those approved to view the private blockchains. Any party approved to view the private blockchains can see all the transactions of that blockchain.

An asymmetric, private blockchain can use multiple techniques to hide usage and identity of other users including obfuscation, rotating obfuscation, split private blockchains, and other techniques.

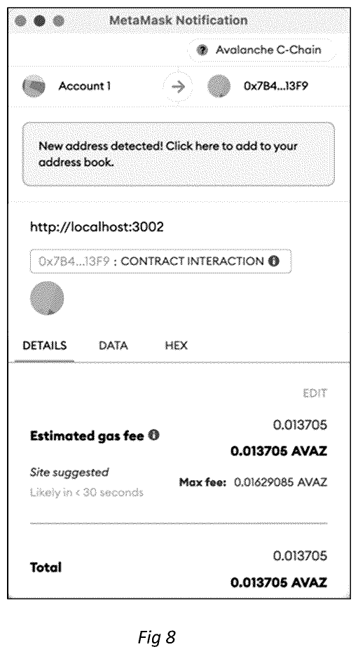

FIG. 8 illustrates an example wallet, in accordance with various example implementations of this disclosure.

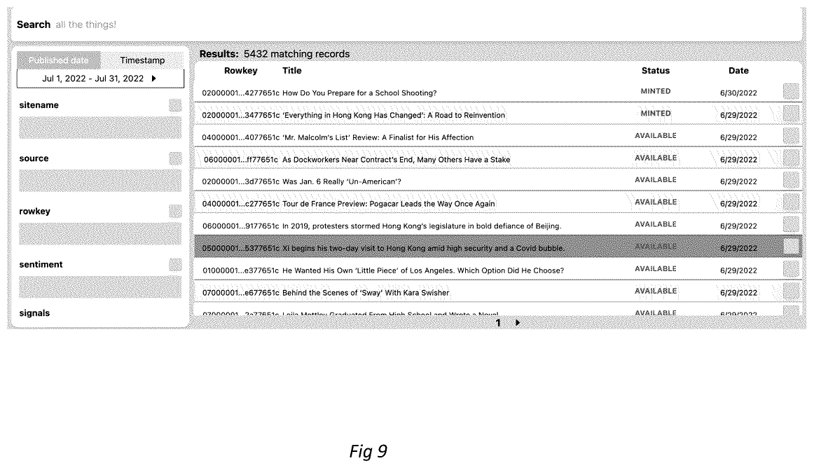

FIG. 9 illustrates an example of searching and building libraries, in accordance with various example implementations of this disclosure.

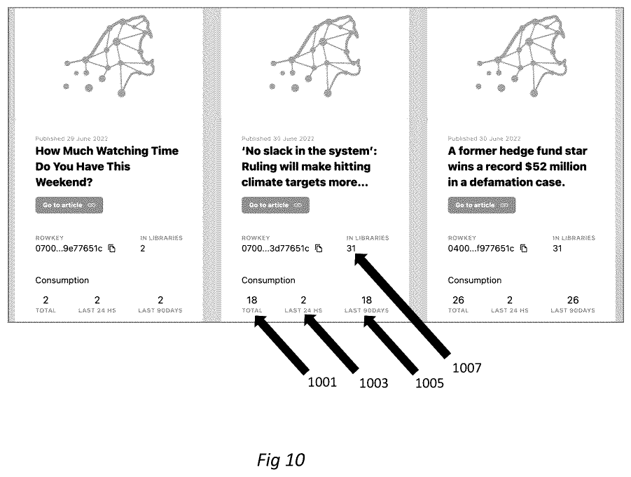

FIG. 10 illustrates an example of usage 1001, 1003, 1005 and tracking of NFT libraries 1007, in accordance with various example implementations of this disclosure.

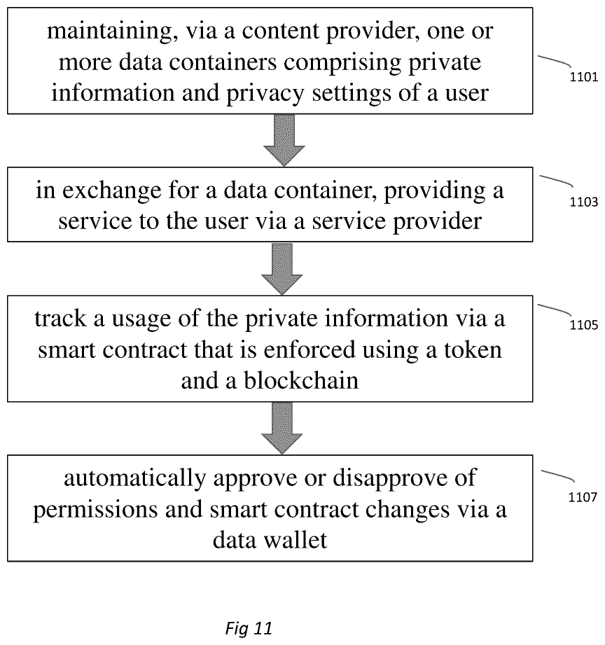

FIG. 11 illustrates an example method for user private access and tracking, in accordance with various example implementations of this disclosure.

The method begins at 1101 with maintaining, via a content provider, one or more data containers comprising private information and privacy settings of a user. The content provider is able to aggregate the content of a plurality of users.

At 1103, a service (e.g., social media service) is provided to the user via a service provider. The service is associated with a smart contract that is determined according to the privacy settings of the user. The smart contract may be updated according to the privacy settings of the user, when the user signs up to the service.

At 1105, the smart contract is tracked and enforced using a token and a blockchain, when the service provider uses, sells or licenses the private information of the user. The user is notified when a third-party uses their private information. The user can be notified in real-time when any of their private information is being packaged or used.

At 1107, the user is able to automatically approve or disapprove of permissions via a data wallet. The user's approval and disapproval may also be tracked. The smart contracts of a user may also be updated automatically according to the user's privacy settings. For example, during a third-party usage of the user's private information within a particular media site, the smart contract may be updated to reflect the extent to which a user's information is used.

The present method and/or system may be realized in hardware, software, or a combination of hardware and software and may consist of an individual system or computer, or a system comprised of multiple systems or computers (i.e. cloud computing and cloud storage service). The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical implementation may comprise one or more application specific integrated circuit (ASIC), one or more field programmable gate array (FPGA), and/or one or more processor (e.g., x86, x64, ARM, PIC, and/or any other suitable processor architecture) and associated supporting circuitry (e.g., storage, DRAM, FLASH, bus interface circuits, etc.). Each discrete ASIC, FPGA, Processor, or other circuit may be referred to as “chip,” and multiple such circuits may be referred to as a “chipset.” Another implementation may comprise a non-transitory machine-readable (e.g., computer readable) medium (e.g., FLASH drive, optical disk, magnetic storage disk, or the like) having stored thereon one or more lines of code that, when executed by a machine, cause the machine to perform processes as described in this disclosure. Another implementation may comprise a non-transitory machine-readable (e.g., computer readable) medium (e.g., FLASH drive, optical disk, magnetic storage disk, or the like) having stored thereon one or more lines of code that, when executed by a machine, cause the machine to be configured (e.g., to load software and/or firmware into its circuits) to operate as a system described in this disclosure.

As used herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As used herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As used herein, the term “exemplary” means serving as a non-limiting example, instance, or illustration. As used herein, the terms “e.g.,” and “for example” set off lists of one or more non-limiting examples, instances, or illustrations. As used herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.). As used herein, the term “based on” means “based at least in part on.” For example, “x based on y” means that “x” is based at least in part on “y” (and may also be based on z, for example).

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A system comprising:
a content provider to maintain one or more data containers comprising private information and privacy settings of a user; and
a service provider to provide a service to the user, wherein the service is associated with a smart contract that is determined according to the privacy settings of the user.

2. The system of claim 1, wherein the content provider aggregates content of a plurality of users.

3. The system of claim 1, wherein when the user signs up to the service, the service provider updates the smart contract according to the privacy settings of the user.

4. The system of claim 1, wherein when the service provider is a social media service.

5. The system of claim 1, wherein when the service provider uses, sells or licenses the private information of the user, the smart contract is tracked and enforced using a token and a blockchain.

6. The system of claim 1, wherein when the user is notified that a third-party used their private information.

7. The system of claim 1, wherein permissions are automatically approved or disapproved via a data wallet.

8. The system of claim 1, wherein an approval by the user is tracked.

9. The system of claim 1, wherein the user is notified in real-time when any of their private information is being packaged or used.

10. The system of claim 1, wherein during a third-party usage of their private information, their smart contract may change according to their privacy settings within a particular media site.

11. A method comprising:
maintaining, via a content provider, one or more data containers comprising private information and privacy settings of a user; and
providing a service to the user via a service provider, wherein the service is associated with a smart contract that is determined according to the privacy settings of the user.

12. The method of claim 11, wherein the content provider aggregates content of a plurality of users.

13. The method of claim 11, wherein the method comprises updating the smart contract according to the privacy settings of the user, when the user signs up to the service.

14. The method of claim 11, wherein when the service provider is a social media service.

15. The method of claim 11, wherein the method comprises tracking and enforcing the smart contract using a token and a blockchain, when the service provider uses, sells or licenses the private information of the user.

16. The method of claim 11, wherein the method comprises notifying the user when a third-party uses their private information.

17. The method of claim 11, wherein the method comprises automatically approving or disapproving of permissions via a data wallet.

18. The method of claim 11, wherein the method comprises tracking the user's approval.

19. The method of claim 11, wherein the method comprises notifying the user in real-time when any of their private information is being packaged or used.

20. The method of claim 11, wherein the method comprises changing the smart contract of a user according to their privacy settings, during a third-party usage of their private information within a particular media site.
